(19) United States
(12) Patent Application Publication
(10) Pub. No.: US 2009/0019373 A1
(43) Pub. Date: Jan. 15, 2009

(54) Government structures in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/827,835

(22) Filed: Jul. 12, 2007

(51) Int. Cl. G06F 3/00

(52) U.S. Cl. 715/751

(57) ABSTRACT

A method, apparatus and system of government structures in a geo-spatial environment are disclosed. In one embodiment, a method of organizing a community network includes obtaining a region on a geo-spatial map, obtaining a first subset of members of the community network associated with the region, determining a second subset of the members with a highest number of points from the first subset, creating a representative body (e.g., based on an activity level of each of the first subset) from the second subset, and enabling the representative body to manage a portion of the community network associated with the region. The method may further include obtaining votes from the first subset corresponding to an elected official of the region, determining one of the second subset with a highest number of the votes, and selecting the one of the second subset as the elected official.

### FIELD OF TECHNOLOGY

This disclosure relates generally to the technical fields of communications and, in one example embodiment, to a method, apparatus, and system of government structures in a geo-spatial environment.

### BACKGROUND

A community network may correspond to a social structure made of nodes which may include individuals and/or organizations, and links between the nodes. The links may correspond to varying degrees of social familiarity, from those of casual acquaintances to close familial bonds. Community networks may be tracked and/or maintained on web-based applications, enabling friends, business partners, and/or other individuals to connect with one another using a variety of tools. Additionally, formation of the community networks on the web-based applications may allow parties to connect with one another regardless of geographic proximity.

In online community networks, users may create profiles that include information such as a name, address, contact information, picture, and/or other personal information. For example, a friend-based community network may allow the users to upload photos to their profiles, while a business community network may allow the users to include work experience, education, and/or references on their profiles. Online community networks may further allow the profiles to be edited by other users. For example, the users may be allowed to leave comments, testimonials, and/or recommendations on other users' profiles and/or associate other users with uploaded pictures, videos, and/or other media.

Connections or links, may be made between users in an online community network. For example, two users on the friend-based community network may become “friends” if both the users approve the connection. Similarly, a business connection may be made on the business community network if two users have worked together and/or are interested in collaborating on a future work. Connections, or links, between the users form the basis of the online community networks and community network theory in general.

As with other communities, the community networks may include individuals with great influence in a particular area, neighborhood, and/or demographic. These individuals may include leaders, contributors, and/or other well-connected people. In addition, individuals with great influence in a particular neighborhood may facilitate transmission of messages between users of the community network as well as set trends, create groups and/or events, and/or otherwise shape the behavior of the other users of the community network. However, there may be inefficiencies in recognizing and/or granting privileges to the influencers by the community which may cause considerable setback to the online communities. As a result, the online communities may suffer due to a lack of recognition and/or granting of privileges to individuals of influence.

### SUMMARY OF THE DISCLOSURE

A method, apparatus and system of government structures in a geo-spatial environment are disclosed. In one aspect, a method of organizing a community network includes obtaining a region (e.g., a city, a county, a state, a country, a group of countries, a continent, a planet, etc.) on a geo-spatial map, obtaining a first subset of a plurality of members of the community network associated with the region, determining a second subset of the members with a highest number of points from the first subset, creating a representative body (e.g., based on an activity level of each of the first subset) from the second subset, and enabling the representative body to manage a portion of the community network associated with the region.

The method may further include obtaining a number of votes from the first subset corresponding to an elected official (e.g., may be a mayor, a governor, a president, a secretary-general, etc.) of the region, determining one of the second subset with a highest number of votes, and selecting the one of the second subset as the elected official. In addition, the first subset may include a plurality of elected officials from a plurality of divisions within the region. The representative body may be created on a periodic basis.

In another aspect, a community network includes a member repository including a plurality of members, and a geo-spatial repository including a plurality of regions (e.g., a city, a county, a state, a country, a group of countries, a continent, a planet, etc.) on a geo-spatial map. The community network further includes a government management module configured to obtain a first subset of the members associated with one of the regions, determine a second subset of the members with a highest number of points from the first subset, create a representative body from the second subset, and enable the representative body to manage a portion of the community network associated with the one of the regions.

The government management module may also be configured to obtain a plurality of votes from the first subset corresponding to an elected official (e.g., may be a mayor, a governor, a president, a secretary-general, etc.) of one of the regions, determine one of the second subset with a highest number of the votes, and select the one of the second subset as the elected official.

In addition, the community network may include a member management module configured to obtain member data (e.g., may include one of a plurality of locations on the geo-spatial map) associated with each of the members. The member management module may further be configured to determine an activity level of each of the members in the member repository (e.g., based on which the representative body is created).

The community network may also include a representative interface accessible by the representative body including a neighborhood management module configured to provide a neighborhood management option to the representative body, a neighborhood cleanup module configured to provide a member profile regulation option to the representative body, a representative communication module configured to send and/or receive messages between each of the second subset of the members, and a forum configured to display a comment from the first subset. The first subset may include a plurality of elected officials from a plurality of divisions within one of the regions.

In yet another aspect, a method of voting on a community network includes obtaining a region request from a user of the community network, displaying a region (e.g., a city, a county, a state, a country, a group of countries, a continent, a planet, etc.) corresponding to the region request on a geo-spatial map, and displaying a representative body including a plurality of members of the community network corresponding to the region.

The method further includes obtaining a vote (e.g., on a periodic basis) for an elected official (e.g., may be a mayor, a governor, a president, a secretary-general, etc.) of the region from the user, determining a residence of the user in the region, determining a validity of the vote (e.g., based on an eligibility of the user and/or an eligibility of one of the members), applying the vote to the one of the members of the representative body based on the residence and/or the validity, and determining the elected official based on the vote. The vote may be placed multiple times by the user. In addition, the representative body may include a plurality of elected officials from a plurality of divisions within the region.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a community network communicating with members of a community, according to one embodiment.

FIG. 2 is a user interface view of electing a next mayor in a region associated with the community network, according to one embodiment.

FIG. 3 is a user interface view of electing a next governor in a region associated with the community network, according to one embodiment.

FIG. 4 is a user interface view of electing a next president in a region associated with the community network, according to one embodiment.

FIG. 5 is a user interface view of electing a next secretary-general in a region associated with the community network, according to one embodiment.

FIG. 6 is a block representation of a representative interface, according to one embodiment.

FIG. 7 is a flow chart of organizing the community network, according to one embodiment.

FIG. 8 is a flow chart of electing an official by voting on the community network, according to one embodiment.

FIG. 9 is a diagrammatic system view of a data processing system in which any of the embodiments disclosed herein may be performed, according to one embodiment.

FIG. 10 is a process flow of the government management module of FIG. 1, according to one embodiment.

Other features of the present embodiments will be apparent from the accompanying drawings and from the detailed description that follows.

### DETAILED DESCRIPTION

A method, apparatus and system of government structures in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

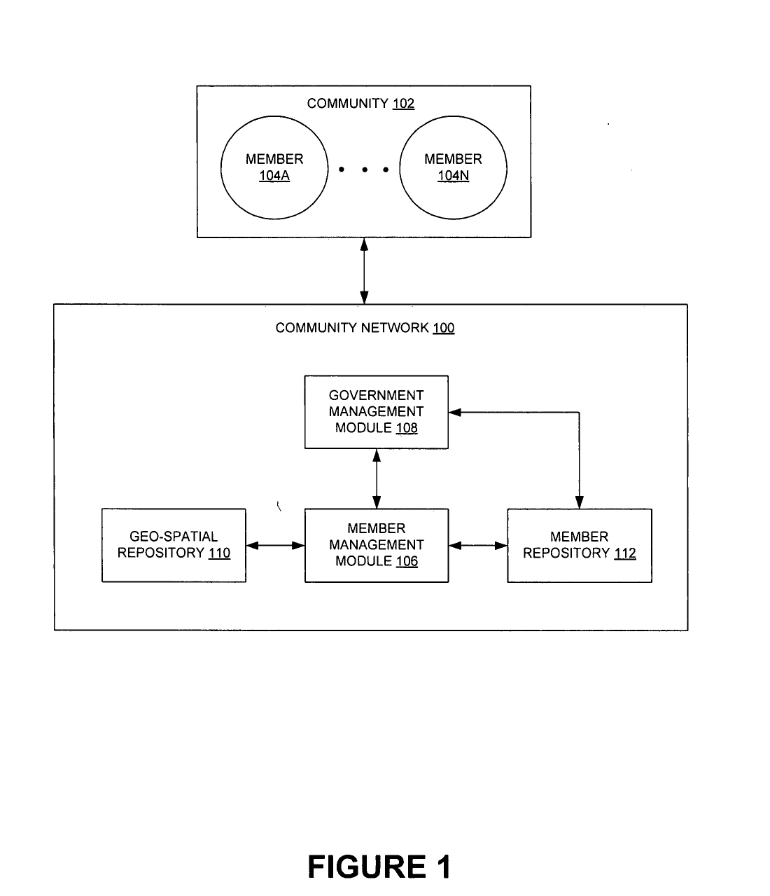

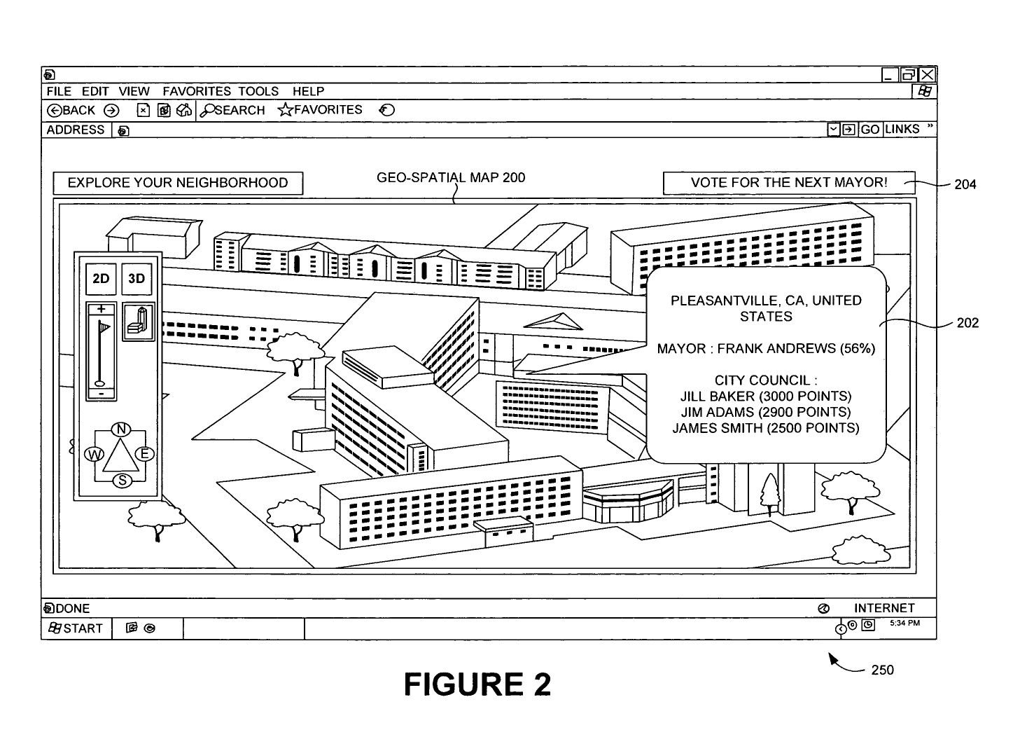

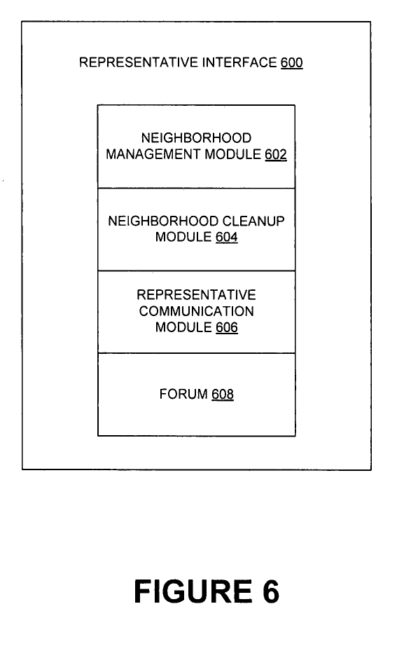

In one embodiment, a method of organizing a community network (e.g., the community network 100 of FIG. 1) includes obtaining (e.g., through the geo-spatial repository 110 of FIG. 1) a region on a geo-spatial map (e.g., the geo-spatial map 200 of FIGS. 2, 3, 4 and 5), obtaining (e.g., through the member repository 112 of FIG. 1) a first subset of members (e.g., the members 104A-N of FIG. 1) of the community network 100 associated with the region, determining a second subset of the members 104A-N with a highest number of points from the first subset 104A-N, creating (e.g., using the government management module 108 of FIG. 1) a representative body (e.g., based on an activity level of each of the first subset 104A-N) from the second subset 104A-N, and enabling the representative body to manage (e.g., through the representative interface 600 of FIG. 6) a portion of the community network 100 associated with the region.

In another embodiment, a community network 100 includes a member repository 112 containing members 104A-N, and a geo-spatial repository 110 containing a number of regions on a geo-spatial map 200. The community network 100 also includes a government management module (e.g., the government management module 108 of FIG. 1) configured to obtain a first subset of the members 104A-N (e.g., from the member repository 112 of FIG. 1) associated with one of the regions, determine a second subset of the members 104A-N with a highest number of points from the first subset 104A-N, create a representative body from the second subset 104A-N, and enable the representative body to manage (e.g., through the representative interface 600 of FIG. 6) a portion of the community network 100 associated with the one of the regions.

In yet another embodiment, a method of voting on a community network 100 includes obtaining a region request from a user (e.g., one of the members 104A-N of FIG. 1) of the community network 100, displaying a region (e.g., a city, a county, a state, a country, a group of countries, a continent, a planet, etc.) corresponding to the region request on a geo-spatial map 200, and displaying a representative body including the members 104A-N of the community network 100 corresponding to the region.

The method further includes obtaining (e.g., using the government management module 108 of FIG. 1) a vote (e.g., on a periodic basis) for an elected official (e.g., may be a mayor, a governor, a president, a secretary-general, etc.) of the region from the user, determining (e.g., using the member management module 106 of FIG. 1) a residence of the user in the region, determining a validity of the vote, applying the vote to the one of the members 104A-N of the representative body based on the residence and/or the validity, and determining (e.g., using the government management module 108 of FIG. 1) the elected official based on the vote.

FIG. 1 is a system view of a community network 100 communicating with members 104A-N of a community 102, according to one embodiment. Particularly, FIG. 1 illustrates the community network 100, the community 102, the members 104A-N, a member management module 106, a government management module 108, a geo-spatial repository 110 and a member repository 112, according to one embodiment.

The community network 100 may be a network formed by association of the members 104A-N having member profiles in the community 102. The community network 100 may enable managing of the community network 100 associated with a particular region in a geo-spatial environment. For example, the particular region may be a geographical area enclosed by a polygon (e.g., a circle, a rectangle, a hexagon, an irregular closed area, etc.) and/or may include a city, a county, a state, a group of countries, a continent, a planet, etc.

The community network 100 may also enable selection (e.g., through the government management module 108 of FIG. 1) of elected officials of a representative body associated with the particular region in the geo-spatial environment. For example, the elected official may be selected based on a highest number of votes obtained from the members 104A-N of the community 102. The elected official may be any one of a mayor, a president, a governor, and a secretary-general. For example, the particular region may be a collection of units (e.g., “New England states”) or as one part of a larger whole (e.g., “New England region of United States”).

In addition, the particular region may tend to be based on political units such as sovereign states, sub national units such as provinces, counties, townships, territories, etc. and multinational groupings, including formally defined units such as European Union, Association of South-East Asian Nations (ASEAN), and North Atlantic Treaty Organization (NATO), as well as informally defined regions such as Third World, Western Europe, Far East and Middle East.

Alternatively, the particular region may also tend to be based on electoral districts such as Washington's 6th congressional district and Tennessee's 1st congressional district, school districts such as Granite School District and Los Angeles Unified School District, economic districts such as Reedy Creek Improvement District, metropolitan areas such as Seattle metropolitan area, and metropolitan districts such as Metropolitan Water Reclamation District of Greater Chicago, Las Vegas-Clark County Library District, Metropolitan Police Service of Greater London, as well as other local districts like York Rural Sanitary District, Delaware River Port Authority, Nassau County Soil and Water Conservation District, and C-TRAN.

The community 102 may be a geographically localized community of the members 104A-N of the community network 100 located within a local neighborhood, a suburb, a village, a city, a county, a state, a nation, a group of nations, a planet, etc. The members 104A-N may be individuals associated with a specific geographic location in the community 102. For example, the members 104A-N may reside in multiple regions (e.g., multiple cities, states, countries, etc.). The members 104A-N may be connected through the community network 100. For example, the individuals may include leaders, social workers, contributors, athletes, people who participate in physical activities, coaches, officials, volunteers, administrators, entrepreneurs and program and/or service providers and/or other well-connected people associated with the community network 100.

The member management module 106 may obtain member data (e.g., location data, address data, etc.) from the geo-spatial repository 110 and/or may determine an activity level of each of the members 104A-N in the member repository 112. The member data may include a number of locations associated with the members 104A-N of the community 102. For example, the activity level may refer to participation of the members 104A-N in the community network 100. The members 104A-N may be involved in building the community network 100, deleting profiles, reporting abuse information and/or comments, etc. Also, the members 104A-N may be unusually connected to other users in the region. In addition, the activity level may be estimated based on a list of activities (e.g., physical, social, etc.) the members 104A-N perform periodically (e.g., daily, weekly, monthly, etc.).

The government management module 108 may create a representative body of the members 104A-N based on the activity level of each of the members 104A-N. In addition, the government management module 108 may select an elected official from the representative body associated with a particular region through determining one of the members 104A-N (e.g., the members 104A-N having a highest number of points) with a highest number of votes. For example, the highest number of votes for the selection of the elected official may be obtained from the members 104A-N of the community network 100.

In addition, the government management module 108 may enable managing (e.g., through the representative interface 600 of FIG. 6) of the community network 100. The geo-spatial repository 110 may be a database that contains map data (e.g., may include location data) to generate various regions on a geo-spatial map 200. For example, the map data may include a number of geographical locations associated with the members 104A-N of the community 102. The various regions associated with the representative body may be generated based on a region request from a user (e.g., may be a member 104) of the community network 100. For example, the region request may include searching a region on the geo-spatial map 200 based on name, latitude/longitude, clicking on a map, etc. The member repository 112 may be a central location where data associated the members 104A-N of the community 102 is stored. For example, the data may include name, age, gender, occupation, activities, hobbies, etc. associated with the members 104A-N of the community 102.

In the example embodiment illustrated in FIG. 1, the community network 100 consists of the member management module 106, the government management module 108, the geo-spatial repository 110 and the member repository 112 communicating with each other. In addition, the community network 100 enables communication between members 104A-N of the representative body and other members 104A-N of the community 102.

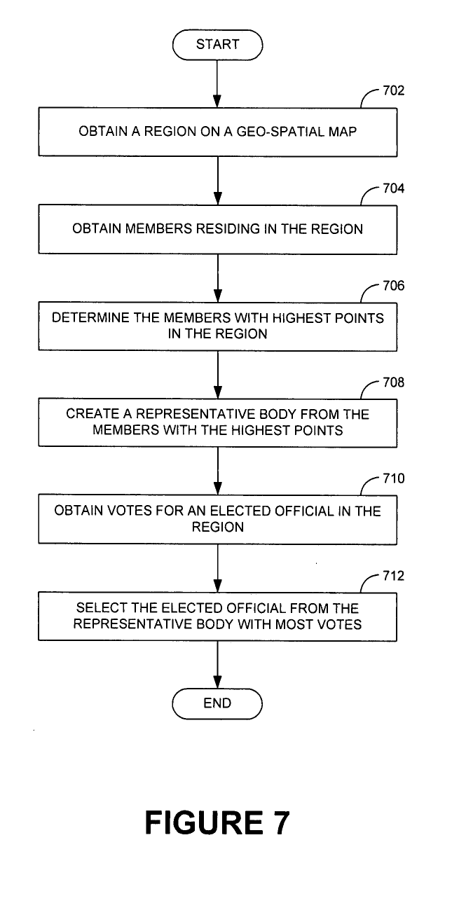

For example, a region (e.g., a city, a county, a state, a country, a group of countries, a continent, a planet, etc.) may be obtained (e.g., using the geo-spatial repository 110 of FIG. 1) on the geo-spatial map 200. A first subset of the members 104A-N of the community network 100 associated with the region may be obtained (e.g., using the member repository 112 of FIG. 1). A second subset of the members 104A-N with a highest number of points may be determined (e.g., in operation 706 of FIG. 7) from the first subset 104A-N.

A representative body may be created (e.g., based on an activity level of each of the first subset 104A-N and/or on a periodic basis) from the second subset 104A-N. The representative body may be enabled to manage (e.g., through the representative interface 600 of FIG. 6) a portion of the community network 100 associated with the region. A number of votes may be obtained (e.g., on a periodic basis) from the first subset 104A-N corresponding to an elected official (e.g., may be a mayor, a governor, a president, a secretary-general, etc.) of the region. One of the second subset 104A-N with a highest number of the votes may be determined (e.g., using the government management module 108 of FIG. 1). The one of the second subset 104A-N may be selected (e.g., upon applying the valid vote from the first subset 104A-N) as the elected official. The first subset of the members 104A-N may include elected officials from divisions within the region.

For example, the member repository 112 may include the members 104A-N, and the geo-spatial repository 110 may include a number of regions (e.g., may include a city, a county, a state, a country, a group of countries, a continent, a planet, etc.). The government management module 108 may be configured to obtain the first subset 104A-N associated with one of the regions and determine the second subset of the members 104A-N with a highest number of points from the first subset 104A-N.

The government management module 108 may be configured to create (e.g., based on the activity level of each of the first subset 104A-N) the representative body (e.g., may include elected officials from divisions within the regions) from the second subset 104A-N and enable the representative body to manage (e.g., through the representative interface 600 of FIG. 6) a portion of the community network 100 associated with one of the regions.

In addition, the government management module 108 may be configured to obtain a number of votes (e.g., on a periodic basis) from the first subset 104A-N corresponding to the elected official (e.g., a mayor, a governor, a president, a secretary-general, etc.) of one of the regions, determine one of the second subset 104A-N with a highest number of the votes and select (e.g., using the government management module 108 of FIG. 1) the one of the second subset 104A-N as the elected official.

The member management module 106 may be configured to obtain member data (e.g., may include one of locations on the geo-spatial map 200) associated with each of the members 104A-N. The member management module 106 may be further configured to determine an activity level (e.g., the activity level may refer to participation of the members 104A-N in the community network 100) of each of the members 104A-N in the member repository 112.

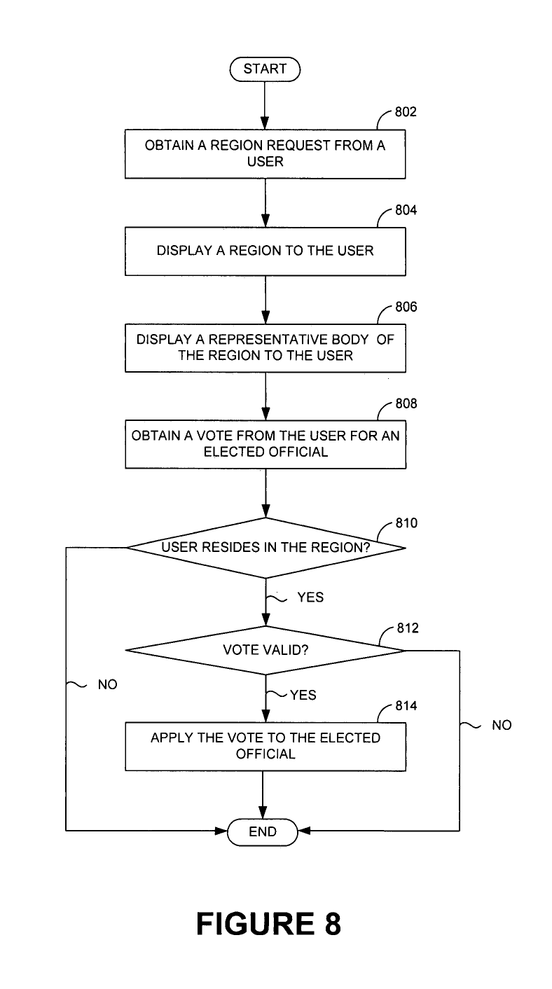

For example, a region request may be obtained (e.g., through operation 802 illustrated in FIG. 8) from a user (e.g., one among the members 104A-N) of the community network 100. A region (e.g., may include a city, a county, a state, a country, a group of countries, a continent, a planet, etc.) may be displayed corresponding to the region request on the geo-spatial map 200. The representative body (e.g., containing elected officials from divisions within the region) including a number of members 104A-N of the community network 100 may be displayed corresponding to the region.

A vote for an elected official (e.g., a mayor, a governor, a president, a secretary-general, etc.) of the region may be obtained (e.g., through the government management module 108 of FIG. 1) from the user. A residence (e.g., a geographic location associated with the residence of the user) of the user in the region may be determined (e.g., in operation 810 of FIG. 8) using the member management module 106 of FIG. 1). A validity of the vote (e.g., may be based an eligibility of the user and/or an eligibility of one of the members 104A-N) may be determined (e.g., in operation 812 of FIG. 8).

The vote may be applied (e.g., in operation 814 of FIG. 8) to one of the members 104A-N of the representative body (e.g., based on the residence and/or the validity). The elected official may be determined based on the vote. For example, the vote (e.g., obtained on a periodic basis) may be placed multiple times by the user.

FIG. 2 is a user interface view 250 of electing a next mayor in a region associated with the community network 100, according to one embodiment. Particularly, FIG. 2 illustrates a geo-spatial map 200, a block 202 and a vote for the next mayor option 204, according to one embodiment.

The geo-spatial map 200 may display a region (e.g., an area enclosed by a polygon) associated with a portion of the community network 100. The geo-spatial map 200 may also display a representative body (e.g., containing the members 104A-N with a highest number of points) within the region associated with the community network 100. For example, the geo-spatial map 200 may display the region based on a region request from a user of the community network 100. The region request may include searching a region on the geo-spatial map 200 based on name, latitude/longitude, clicking on a map, etc. For example, the region associated with the representative body (e.g., city council) may include a city (e.g., Pleasantville).

The block 202 may display details associated with an elected official (e.g., mayor) in the region (e.g., a city). For example, the details of the elected official may include name and/or location of the elected official, and/or a number of votes obtained by the elected official. The block 202 may also display details of the representative body associated with the elected official of the region. The details of the representative body may include name of the members 104A-N of city council, and a number of points associated with each of the members 104A-N.

The vote for the next mayor option 204 may enable the users to vote from among the second subset of the members 104A-N corresponding to an office (e.g., next mayor of the city). The vote obtained from the users may be applied to one of the members 104A-N based on a residence and/or an eligibility of the user. For example, the vote may be obtained on a periodic basis.

In the example embodiment illustrated in FIG. 2, the user interface view 250 displays a city (e.g., requested by the user) and/or a representative body (e.g., mayor and the members 104A-N of city council) associated with the city on the geo-spatial map 200. The block 202 displays city as “Pleasantville, Calif., United States”, the mayor of the city as “Frank Andrews”, a percentage of votes obtained by the mayor as “56%” on the geo-spatial map 200. The block 202 also displays the members 104A-N of the city council as “Jill Baker”, “Jim Adams”, and “James Smith” and the number of points obtained by Jill Baker as “3000 points”, Jim Adams as “2900 points”, and James Smith as “2500 points”. The user interface view 250 may enable the users of the community network 100 to vote for the next mayor of Pleasantville, Calif., United States through the vote for the next mayor option 204.

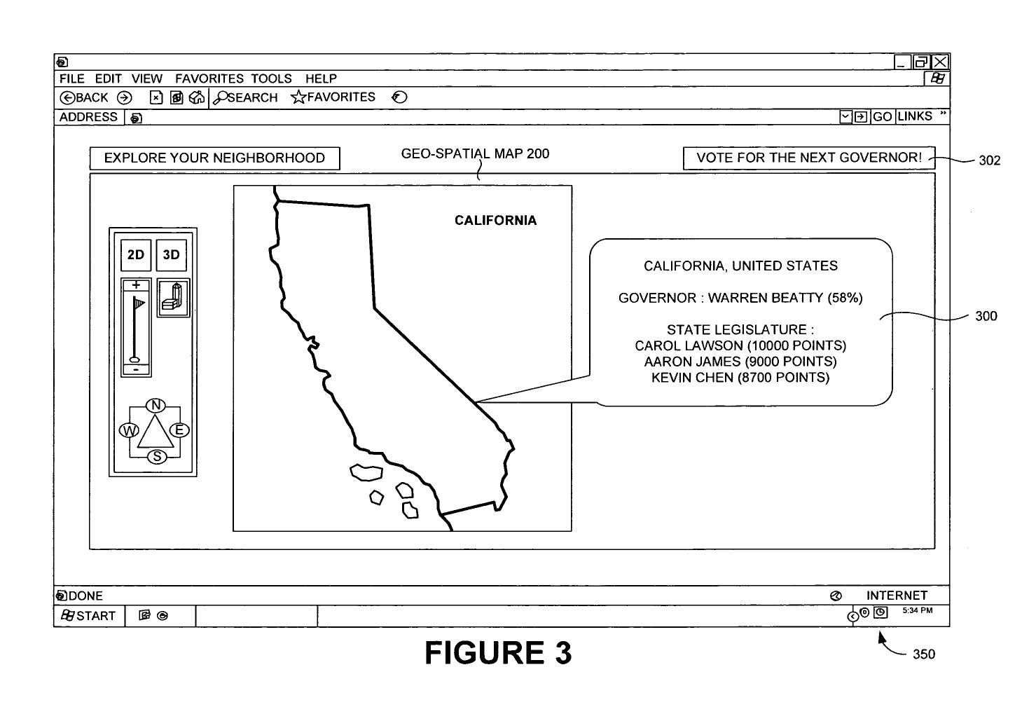

FIG. 3 is a user interface view 350 of electing a next governor in a region associated with the community network 100, according to one embodiment. Particularly, FIG. 3 illustrates the geo-spatial map 200, a block 300 and a vote for the next governor option 302, according to one embodiment.

The geo-spatial map 200 may display a region (e.g., a state) associated with a portion of the community network 100. The geo-spatial map 200 may also display a representative body (e.g., containing the members 104A-N with a highest number of points) within the region associated with the community network 100. The region associated with the representative body (e.g., state legislature) may include a state (e.g., Calif.). For example, the geo-spatial map 200 may display the state based on a region request from a user of the community network 100. The region request may be obtained though a search query provided by the user.

The block 300 may display details associated with an elected official (e.g., governor) in the region (e.g., a state). For example, the details of the elected official may include name and/or location of the elected official, and/or a number of votes obtained by the elected official. The block 300 may also display details of the representative body associated with the elected official of the region. The details of the representative body may include names of the members 104A-N of state legislature, a number of points associated with each of the members 104A-N.

The vote for the next governor option 302 may enable the users to vote for from among the second subset of the members 104A-N corresponding to an office (e.g., next governor of the state). The vote obtained (e.g., on a periodic basis) from the users may be applied to one of the members 104A-N based on a residence and/or an eligibility of the user.

In the example embodiment illustrated in FIG. 3, the user interface view 350 displays a state (e.g., requested by the user) and a representative body (e.g., governor and the members 104A-N of state legislature) associated with the state on the geo-spatial map 200. The block 300 displays the state as “California, United States”, the governor of the state as “Warren Beatty”, a percentage of votes obtained by the governor as “58%” on the geo-spatial map 200. The block 300 also displays the members 104A-N of the state legislature as “Carol Lawson”, “Aaron James”, and “Kevin Chen” and the number of points obtained by Carol Lawson as “10000 points”, Aaron James as 9000 points”, and “Kevin Chen as “8700 points”. The user interface view 350 may enable the users of the community network 100 to vote for the next governor of California, United States through the vote for the next governor option 302.

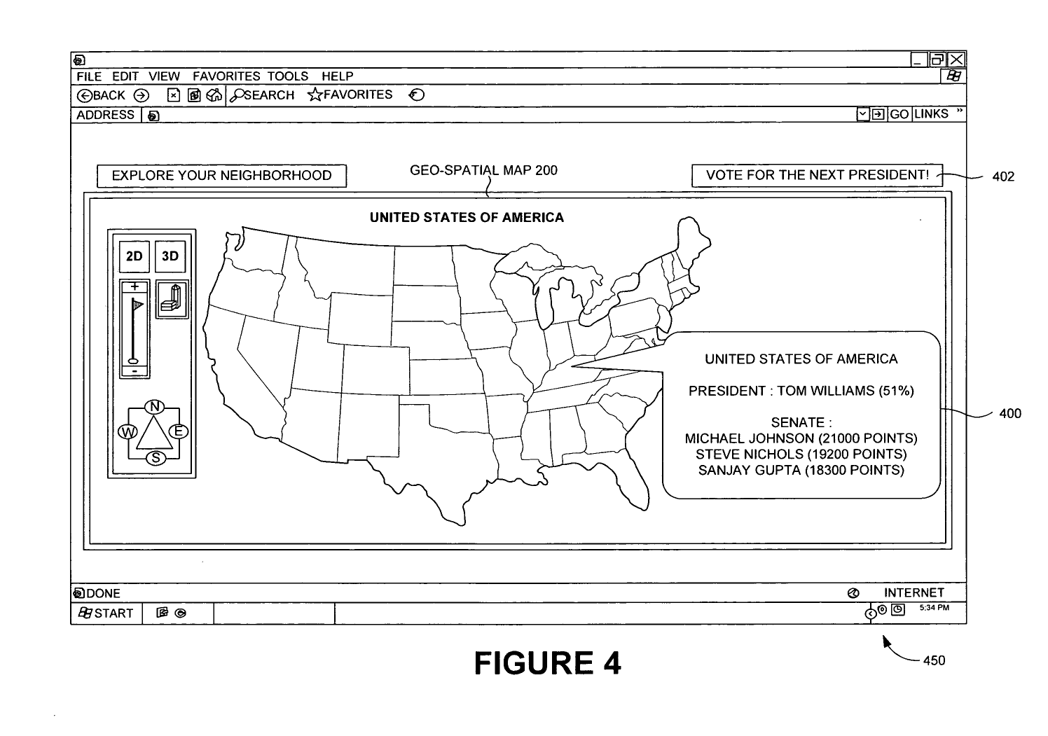

FIG. 4 is a user interface view 450 of electing a next president in a region associated with the community network 100, according to one embodiment. Particularly, FIG. 4 illustrates the geo-spatial map 200, a block 400 and a vote for the next president option 402, according to one embodiment.

The geo-spatial map 200 may display a region (e.g., a country) associated with a portion of the community network 100. The geo-spatial map 200 may also display a representative body (e.g., containing the members 104A-N with a highest number of points) within the region associated with the community network 100. The region associated with the representative body (e.g., senate) may include a country (e.g., United States of America). For example, the geo-spatial map 200 may display the country based on a region request from a user of the community network 100. In one example embodiment, the region request may be obtained through a search query (e.g., may include a name, a latitude, a longitude, an address, etc.) provided by the user.

The block 400 may display details associated with an elected official (e.g., president) in the region (e.g., a country). For example, the details of the elected official may include name and/or location of the elected official, and/or a number of votes obtained by the elected official. The block 400 may also display details of the representative body associated with the elected official of the region. The details of the representative body may include names of the members 104A-N of senate, and numbers of points associated with each of the members 104A-N.

The vote for the next president option 402 may enable the users to vote for from among the second subset of the members 104A-N corresponding to an office (e.g., next president of the country). The vote obtained from the users may be applied to one of the members 104A-N based on a residence and/or an eligibility of the user.

In the example embodiment illustrated in FIG. 4, the user interface view 450 displays a country (e.g., requested by the user) and a representative body (e.g., president and members 104A-N of senate) associated with the country on the geo-spatial map 200. The block 400 displays country as “United States of America”, the president of the country as “Tom Williams”, a percentage of votes obtained by the president as “51%” on the geo-spatial map 200. The block 400 also displays the members 104A-N of the senate as “Michael Johnson”, “Steve Nichols”, and “Sanjay Gupta” and the number of points obtained by Michael Johnson as “21000 points”, Steve Nichols as “19200 points”, and Sanjay Gupta as “18300 points”. The user interface view 450 may enable the users of the community network 100 to vote for the next “president” of the “United States of America” through the vote for the next president option 402.

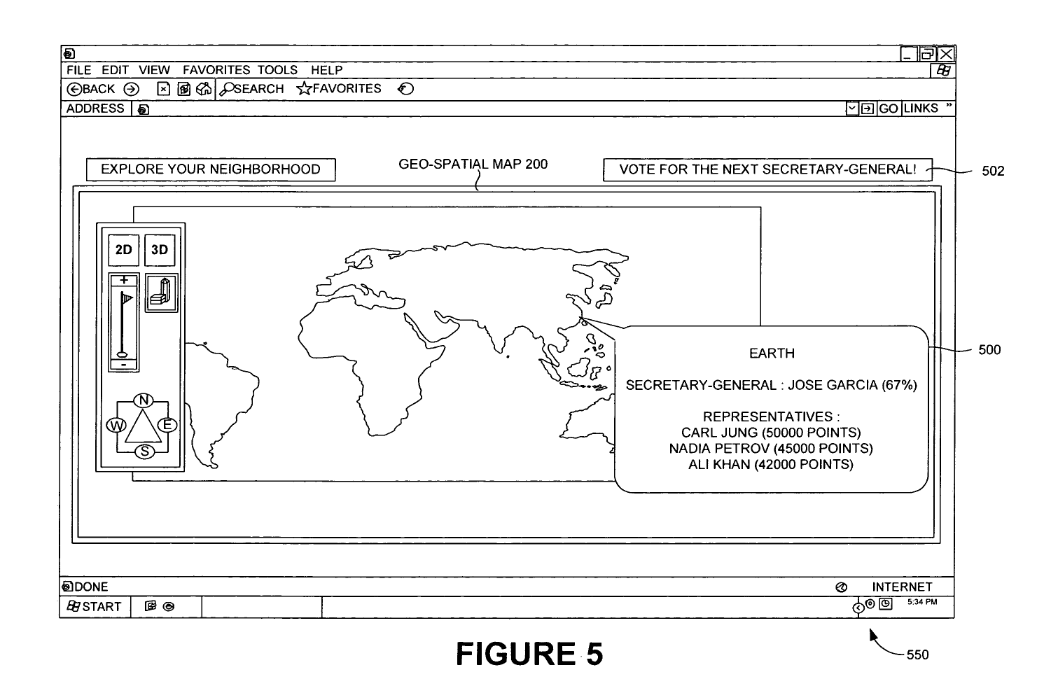

FIG. 5 is a user interface view 550 of electing a next secretary-general in a region associated with the community network 100, according to one embodiment. Particularly, FIG. 5 illustrates the geo-spatial map 200, a block 500 and a vote for the next secretary-general option 502, according to one embodiment.

The geo-spatial map 200 may display a region (e.g., a planet) associated with the community network 100. The geo-spatial map 200 may also display a representative body (e.g., containing the members 104A-N with a highest number of points) within the region associated with the community network 100. The region associated with the representative body (e.g., representatives) may include a planet (e.g., Earth). For example, the geo-spatial map 200 may display the planet based on a region request from a user of the community network 100. The region request may be obtained based on a search query (e.g., a name, a latitude/longitude, an address, etc.) provided by the user of the community network 100.

The block 500 may display details associated with an elected official (e.g., secretary-general) in the region (e.g., a planet). For example, the details of the elected official may include name and/or location of the elected official, and/or a number of votes obtained by the elected official. The block 500 may also display details of the representative body associated with the elected official of the region (e.g., a planet). The details of the representative body may include names of the members 104A-N of the representative body, a number of points associated with each of the members 104A-N.

The vote for the next secretary-general option 502 may enable the users to vote for from among the second subset of the members 104A-N corresponding to an office (e.g., next secretary-general of the Earth). The vote obtained (e.g., on a periodic basis) from the users may be applied to one of the members 104A-N based on a residence of the user and/or an eligibility of the user.

In the example embodiment illustrated in FIG. 5, the user interface view 550 displays a planet (e.g., requested by the user) and a representative body (e.g., secretary-general and representatives) associated with the planet on the geo-spatial map 200. The blocks 500 displays the planet as “Earth”, the secretary-general of the planet as “Jose Garcia”, a percentage of votes obtained by the secretary-general as “67%” on the geo-spatial map 200. The block 500 also displays the members 104A-N of the representatives as “Carl Jung”, “Nadia Petrov”, and “Ali Khan” and the number of points obtained by Carl Jung as “50000 points”, Nadia Petrov as “45000 points”, and Ali Khan as “42000 points”. The user interface view 550 may enable users of the community network 100 to vote for the next secretary-general of the Earth through the vote for the next secretary-general option 502.

FIG. 6 is a block representation of a representative interface 600, according to one embodiment. Particularly, FIG. 6 illustrates a neighborhood management module 602, a neighborhood cleanup module 604, a representative communication module 606 and a forum 608, according to one embodiment.

The neighborhood management module 602 may enable a representative body to manage a portion of the community network 100 associated with a particular region. For example, the neighborhood management module 602 may provide a neighborhood management option to the representative body for managing the community network 100 associated with the members 104A-N. The representative body may manage general activities by users, unauthorized deletion of profiles, and/or posting of slanderous comments and/or blogs.

The neighborhood cleanup module 604 may enable the representative body to regulate member profiles in the community network 100. The representative body may regulate profiles of the members 104A-N through a member profile regulation option provided by the representative interface 600. The regulation of member profiles may include unauthorized updation, deletion, creation, edition of profiles associated with the members 104A-N of the community 102, etc. The representative communication module 606 may enable the members 104A-N to communicate (e.g., for managing the community network 100 associated with the particular region) with each other through a communication medium. For example, the communication medium may include voice chat, email, IM, text message, etc.

The forum 608 may display comments from the members 104A-N of the community network 100. For example, the forum 608 may be web forums, message boards, discussion boards, discussion groups (e.g., electronic), discussion forums, bulletin boards, etc. which facilitate the members 104A-N to hold discussions and/or post user-generated content. In one example embodiment, the comments within the forum 608 may be displayed either in chronological order or as threaded discussions.

The neighborhood management module 602 of the representative interface 600 (e.g., accessible by the representative body) may be configured to provide the neighborhood management option to the representative body. The neighborhood cleanup module 604 of the representative interface 600 may be configured to provide the member profile regulation option to the representative body. The representative communication module 606 may be configured to send and/or receive messages between each of the second subset of the members 104A-N. The forum 608 of the representative interface 600 may be configured to display a comment from the first subset 104A-N.

FIG. 7 is a flow chart of organizing the community network 100, according to one embodiment. In operation 702, a region is obtained (e.g., from the geo-spatial repository 110 of FIG. 1) on a geo-spatial map 200. For example, the region may be based on the geographic radius around members 104A-N of the community network 100 and/or may correspond to a defined geographical area of city, county, state, country, group of countries, etc., where the member is located in. The region may include city, county, state, country, continent, etc. For example, the region (e.g., associated with the community network 100) may be obtained on the geo-spatial map 200 based on user's request.

In operation 704, members 104A-N residing in the region are obtained. For example, the members 104A-N residing in the region may be obtained from the member repository 112. In operation 706, the members 104A-N with a highest number of points in the region are determined (e.g., using the government management module 108 of FIG. 1). The number of points may be determined based on an activity level of the members 104A-N in the region. For example, the activity level of each of the members 104A-N may be based on participation of the members 104A-N in the community network 100. The activity level may be estimated based on a list of the activities (e.g., physical, social, etc.) the members 104A-N of the community network 100 performs from day to day.

In operation 708, a representative body is created (e.g., by the government management module 108 of FIG. 1) from the members 104A-N with the highest number of points in the region. For example, the representative body may be created based on an activity level of each of the members 104A-N, and/or on a periodic basis. The representative body may be created to manage the community network 100 associated with a city, a county, a state, a group of countries, a continent, a planet, etc.

In operation 710, votes may be obtained (e.g., on a periodic basis) for an elected official in the region. The elected official may include a mayor, a governor, a president, a secretary-general, etc. The votes obtained may be applied to the members 104A-N of the representative body based on determination of validity of vote and/or residence of the user in the region. For example, the validity of vote may be based on an eligibility of one of the members 104A-N and/or the voter.

In operation 712, the elected official is selected from the members 104A-N of the representative body with a highest number of votes. For example, the elected official associated with the region may be elected by the members 104A-N of the community network 100 through an online voting system.

FIG. 8 is a flow chart of electing an official by voting on the community network 100, according to one embodiment. In operation 802, a region request is obtained from a user. For example, the users of the community network 100 may be the members 104A-N of the community 102. In one example embodiment, the region request may be obtained through a search query provided by the user. In addition, the region request may be based on a geographic radius (e.g., 5 miles) around the user (e.g., a member 104) of the community network 100.

In operation 804, a region corresponding to the region request may be displayed (e.g., using the geo-spatial repository 110 of FIG. 1) on a geo-spatial map (e.g., the geo-spatial map 200 of FIGS. 2, 3, 4 and 5). The region displayed on the geo-spatial map 200 may correspond to a defined geographical area of a city, a county, a state, a group of countries, a continent, a planet, etc. in which the residence of the user is located.

In operation 806, a representative body containing the members 104A-N of the community network 100 of the region may be displayed. The representative body displayed on the geo-spatial map 200 may be a group of members 104A-N formed (e.g., using the government management module 108 of FIG. 1) based on an activity level of each of the members 104A-N. For example, the activity level may be based on participation of the members 104A-N in the community network 100. The members 104A-N may be involved in building the community network 100, deleting profiles, reporting abuse information and/or comments, etc. Also, the members 104A-N may be unusually (e.g., significantly) connected to other users in the region.

In operation 808, a vote may be obtained from the user for an elected official. For example, the vote corresponding to the elected official may be obtained on a periodic basis (e.g., daily, weekly, monthly, etc.).

In operation 810, it is determined (e.g., using the geo-spatial repository 110 and the member repository 112 of FIG. 1) whether the user (e.g., who has provided the region request) resides in the region (e.g., displayed corresponding to the region request) or not. If the user does not reside in the requested region (e.g., displayed on the geo-spatial map 200) then the process of voting (e.g., the elected official in the region) on the community network 100 may terminate.

In operation 812, it is determined whether the vote obtained from the user of the community network 100 corresponding to the elected official is valid or not. If it is determined that the vote obtained from the user of the community network 100 is not valid, then the process of voting may terminate. The validity of vote is determined based on an eligibility of the user and/or an eligibility of one of the members 104A-N.

In operation 814, the vote obtained from the user is applied to the one of the members 104A-N of the representative body in the region. For example, the vote is applied to the elected official based on the validity and/or residence of the region (e.g., within the region displayed on the geo-spatial map 200).

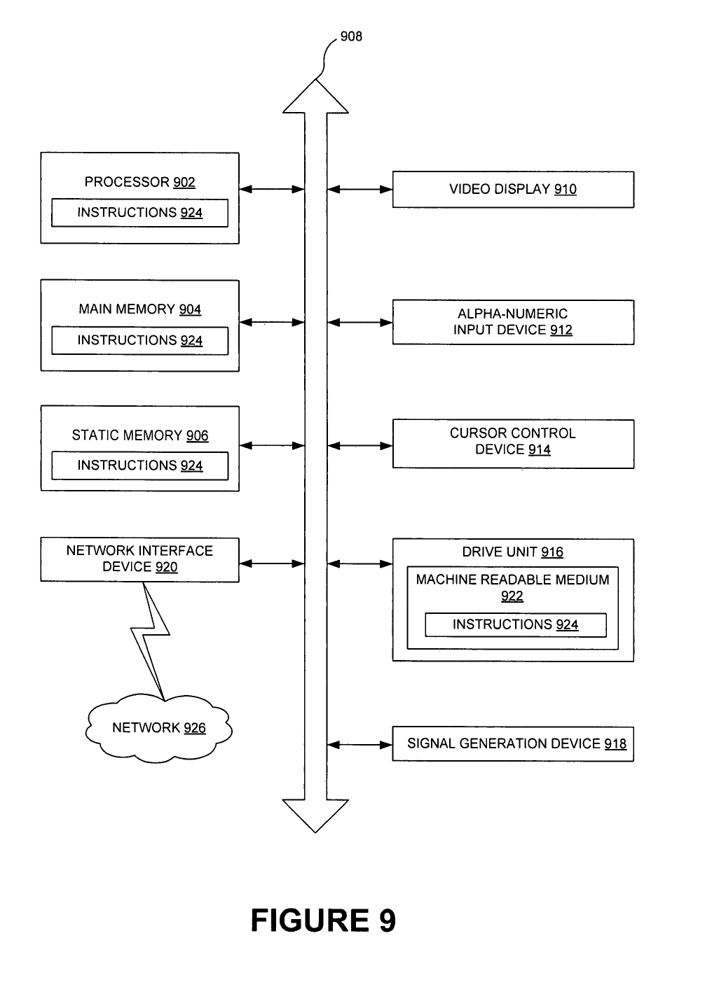

FIG. 9 is a diagrammatic system view 900 of a data processing system in which any of the embodiments disclosed herein may be performed, according to one embodiment. Particularly, the diagrammatic system view 900 of FIG. 9 illustrates a processor 902, a main memory 904, a static memory 906, a bus 908, a video display 910, an alpha-numeric input device 912, a cursor control device 914, a drive unit 916, a signal generation device 918, a network interface device 920, a machine readable medium 922, instructions 924 and a network 926, according to one embodiment.

The diagrammatic system view 900 may indicate a personal computer and/or a data processing system in which one or more operations disclosed herein are performed. The processor 902 may be a microprocessor, a state machine, an application specific integrated circuit, a field programmable gate array, etc. (e.g., Intel® Pentium® processor). The main memory 904 may be a dynamic random access memory and/or a primary memory of a computer system. The static memory 906 may be a hard drive, a flash drive, and/or other memory information associated with the data processing system. The bus 908 may be an interconnection between various circuits and/or structures of the data processing system.

The video display 910 may provide graphical representation of information on the data processing system. The alpha-numeric input device 912 may be a keypad, a keyboard and/or any other input device of text (e.g., special device to aid the physically handicapped). The cursor control device 914 may be a pointing device such as a mouse.

The drive unit 916 may be the hard drive, a storage system, and/or other longer term storage subsystem. The signal generation device 918 may be a bios and/or a functional operating system of the data processing system. The network interface device 920 may be a device that may perform interface functions such as code conversion, protocol conversion and/or buffering required for communication to and from the network 926. The machine readable medium 922 may provide instructions on which any of the methods disclosed herein may be performed. The instructions 924 may provide source code and/or data code to the processor 902 to enable any one or more operations disclosed herein.

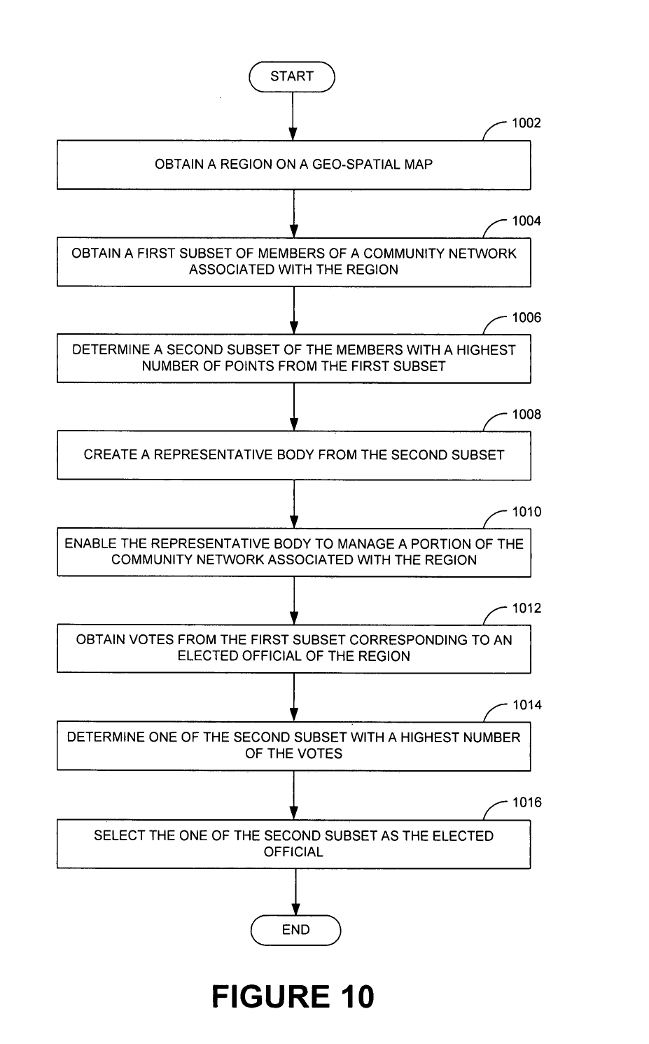

FIG. 10 is a process flow of the government management module 108 of FIG. 1, according to one embodiment. In operation 1002, a region (e.g., a city, a county, a state, a group of countries, a continent, a planet, etc.) may be obtained (e.g., using the geo-spatial repository 110 of FIG. 1) on a geo-spatial map (e.g., geo-spatial map 200 of FIG. 2). In operation 1004, a first subset of members 104A-N of a community network 100 associated with the region may be obtained (e.g., using the member repository 112 of FIG. 1).

In operation 1006, a second subset of the members 104A-N with a highest number of points may be determined (e.g., using the government management module 108 of FIG. 1) from the first subset 104A-N. In operation 1008, a representative body may be created (e.g., based on an activity level associated with a number of points of each of the first subset 104A-N) from the second subset 104A-N. In operation 1010, the representative body may be enabled to manage a portion of the community network 100 associated with the region (e.g., through the representative interface 600 of FIG. 6).

In operation 1012, a number of votes may be obtained (e.g., on a periodic basis) from the first subset 104A-N corresponding to an elected official (e.g., may include a mayor, a president, a governor, a secretary-general, etc.) of the region. In operation 1014, one of the second subset 104A-N with a highest number of the votes may be determined (e.g., using the government management module 108 of FIG. 1). In operation 1016, the one of the second subset 104A-N may be selected (e.g., using the government management module 108 of FIG. 1) as the elected official.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., Application Specific Integrated Circuitry (ASIC) and/or in Digital Signal Processor (DSP) circuitry). For example, the member management module 106, the government management module 108 and other modules of FIGS. 1-10 may be enabled using a member management circuit, a government management circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of organizing a community network, comprising:
obtaining a region on a geo-spatial map;
obtaining a first subset of a plurality of members of the community network associated with the region;
determining a second subset of the plurality of members with a highest number of points from the first subset;
creating a representative body from the second subset; and
enabling the representative body to manage a portion of the community network associated with the region.

2. The method of claim 1, further comprising:
obtaining a plurality of votes from the first subset corresponding to an elected official of the region;
determining one of the second subset with a highest number of the plurality of votes; and
selecting the one of the second subset as the elected official.

3. The method of claim 2, wherein the elected official is at least one of a mayor, a governor, a president, and a secretary-general.

4. The method of claim 1, wherein the region is at least one of a city, a county, a state, a country, a group of countries, a continent, and a planet.

5. The method of claim 1, wherein the representative body is created based on an activity level of each of the first subset.

6. The method of claim 1, wherein the first subset comprises a plurality of elected officials from a plurality of divisions within the region.

7. The method of claim 1, wherein the representative body is created on a periodic basis.

8. The method of claim 1 in a form of a machine-readable medium embodying a set of instructions that, when executed by a machine, causes the machine to perform the method of claim 1.

9. A community network, comprising:
a member repository comprising a plurality of members;
a geo-spatial repository comprising a plurality of regions on a geo-spatial map; and
a government management module configured to:
obtain a first subset of the plurality of members associated with one of the plurality of regions;
determine a second subset of the plurality of members with a highest number of points from the first subset;
create a representative body from the second subset; and
enable the representative body to manage a portion of the community network associated with the one of the plurality of regions.

10. The community network of claim 9, further comprising:
a member management module configured to obtain member data associated with each of the plurality of members, wherein the member data comprises one of a plurality of locations on the geo-spatial map.

11. The community network of claim 10, wherein the member management module is further configured to:
determine an activity level of each of the plurality of members in the member repository, wherein the representative body is created based on the activity level of each of the first subset.

12. The community network of claim 9, further comprising:
a representative interface accessible by the representative body, comprising:
a neighborhood management module configured to provide a neighborhood management option to the representative body;
a neighborhood cleanup module configured to provide a member profile regulation option to the representative body;
a representative communication module configured to send and receive messages between each of the second subset of the plurality of members; and
a forum configured to display a comment from at least one of the first subset.

13. The community network of claim 9, wherein the government management module is further configured to:
obtain a plurality of votes from the first subset corresponding to an elected official of the one of the plurality of regions;
determine one of the second subset with a highest number of the plurality of votes; and
select the one of the second subset as the elected official.

14. The community network of claim 13, wherein the elected official is at least one of a mayor, a governor, a president, and a secretary-general.

15. The community network of claim 9, wherein each of the plurality of regions is at least one of a city, a county, a state, a country, a group of countries, a continent, and a planet.

16. The community network of claim 9, wherein the first subset comprises a plurality of elected officials from a plurality of divisions within the one of the plurality of regions.

17. A method of voting on a community network, comprising:
obtaining a region request from a user of the community network;
displaying a region corresponding to the region request on a geo-spatial map;
displaying a representative body comprising a plurality of members of the community network corresponding to the region;
obtaining a vote for an elected official of the region from the user;
determining a residence of the user in the region;
determining a validity of the vote;
applying the vote to one of members of the representative body based on the residence and the validity; and
determining the elected official based on the vote.

18. The method of claim 17, wherein the validity of the vote is based on at least one of an eligibility of the user and an eligibility of the one of the plurality of members, wherein the vote is placed multiple times by the user, and wherein the vote is obtained on a periodic basis.

19. The method of claim 17, wherein the elected official is at least one of a mayor, a governor, a president, and a secretary-general.

20. The method of claim 17, wherein the region is at least one of a city, a county, a state, a country, a group of countries, a continent, and a planet.

21. The method of claim 17, wherein the representative body comprises a plurality of elected officials from a plurality of divisions within the region.
